(19) United States
(12) Patent Application Publication
(10) Pub. No.: US 2019/0042308 A1
(43) Pub. Date: Feb. 7, 2019

(54) TECHNOLOGIES FOR PROVIDING EFFICIENT SCHEDULING OF FUNCTIONS

(71) Applicant: Intel Corporation, Santa Clara, CA (US)

(72) Inventors: Mohan J. Kumar, Aloha, OR (US); Krishna Bhuyan, Sammamish, WA (US)

(21) Appl. No.: 16/118,840

(22) Filed: Aug. 31, 2018

(51) Int. Cl. G06F 9/48

(52) U.S. Cl. CPC G06F 9/4881

(57) ABSTRACT

Technologies for providing efficient scheduling of functions include a compute device. The compute device is configured to obtain a function dependency graph indicative of data dependencies between functions to be executed in a networked set of compute devices, perform a cluster analysis of the execution of the functions in the networked set of compute devices to identify additional data dependencies between the functions, and update, based on the cluster analysis, the function dependency graph.

### BACKGROUND

In a typical data center in which functions are provided on an as requested basis for a customer (e.g., a function-as-a-service (FAAS) model), the scheduling of the functions is often performed by identifying a compute device having available compute capacity (e.g., a relatively small load) at the time the request is received. Often, a requested function is one of a set of functions that are interdependent, such that the output data produced through the execution of one function (e.g., function A) defines input data for a dependent function (e.g., function B). In the typical data center implementing a FAAS model, the output data produced by function A may reside on a first compute device and function B may be scheduled to be executed on a second compute device that is communicatively coupled to the first compute device through a network. As such, to enable the execution of the dependent function (e.g., function B) the first compute device typically sends the output data to the second compute device through the network, utilizing traditional network protocols (e.g., HTTP, TCP, IP, etc.) and incurring significant latency, particularly in cases where the second compute device is several network hops (e.g., network devices, such as routers) away from the first compute device.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified diagram of at least one embodiment of a system for providing efficient scheduling of functions among multiple compute devices;

FIG. 2 is a simplified block diagram of at least one embodiment of a compute device included in the system of FIG. 1; and

FIGS. 3-5 are a simplified block diagram of at least one embodiment of a method for providing efficient scheduling of functions that may be performed by a compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

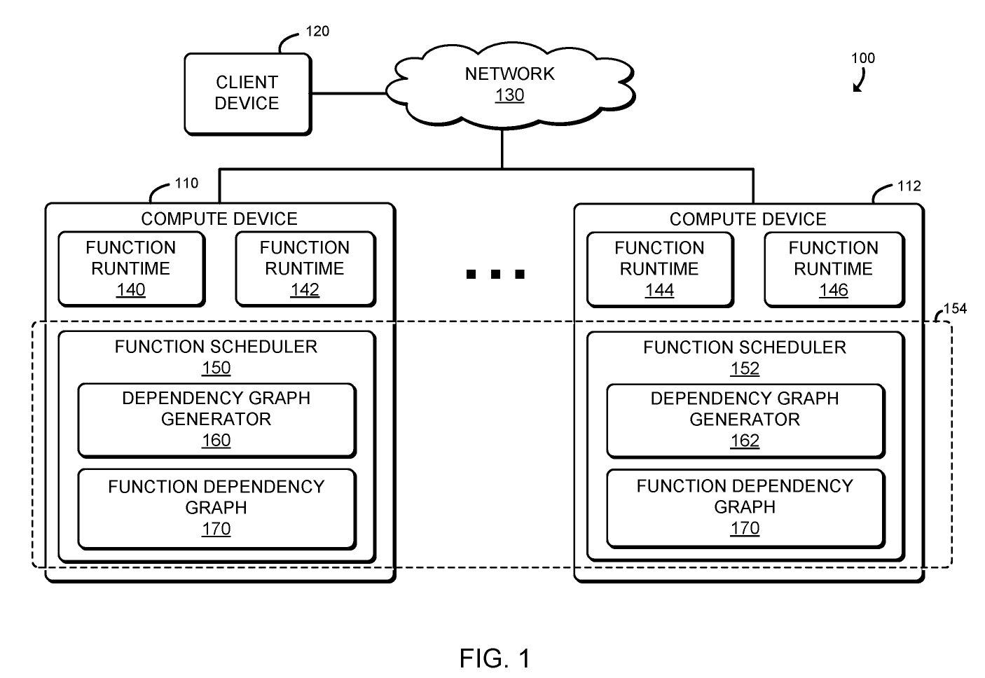

Referring now to FIG. 1, a system 100 for providing efficient scheduling of functions includes a set of compute devices 110, 112. While, for clarity, only two compute devices 110, 112 are shown in FIG. 1, the system 100 may include any number of compute devices (e.g., tens, hundreds, or thousands of compute devices). The compute devices 110, 112, in the illustrative embodiment, are located in a data center and perform functions (e.g., in function runtimes 140, 142, 144, 146, such as containers or virtual machines) on behalf of a customer (e.g., an operator of a client device 120) on an as requested basis. In doing so, the compute devices 110, 112 utilize a function dependency graph 170 which may be embodied as any data structure (e.g., a directed acyclic graph, a linked list, etc.) that indicates data dependencies between functions (e.g., function B utilizes output data from function A as input data) to determine where to schedule the execution of each function (e.g., which compute device 110, 112 should execute each function) to reduce latencies that may otherwise be incurred in instantiating a function on one of the compute devices 110, 112 and sending, through a network 130, a set of data (e.g., data produced by a function A) to be used as input data for the function to be executed (e.g., function B).

The function dependency graph 170 may be initially generated by a dependency graph generator 160, 162 (e.g., software, specialized circuitry, a processor, a co-processor, etc.), from hints (e.g., source code comments) or metadata provided by a developer of an application (e.g., a set of interrelated functions) and/or from an analysis of source code that defines the functions. Subsequently, the dependency graph generators 160, 162 update the function dependency graph 170 as the functions are scheduled and executed among the compute devices 110, 112, as explained in more detail herein. While shown as separate entities, the function schedulers 150, 152 may work together (e.g., share data) as a distributed function scheduler 154 to schedule the execution of functions among the compute devices 110, 112, analyze the function dependency graph 170 and update the function dependency graph 170 over time to identify further data dependencies between the functions (e.g., through a clustering analysis of run time logs) and further reduce latencies in the scheduling and execution of functions among the compute devices 110, 112. Accordingly, the system 100 provides more efficient (e.g., lower latency) scheduling and execution of functions compared to typical data centers in which functions are scheduled on compute devices without regard the latencies incurred in transferring output data sets from functions across the network to enable the execution of other functions that depend on those output data sets as input.

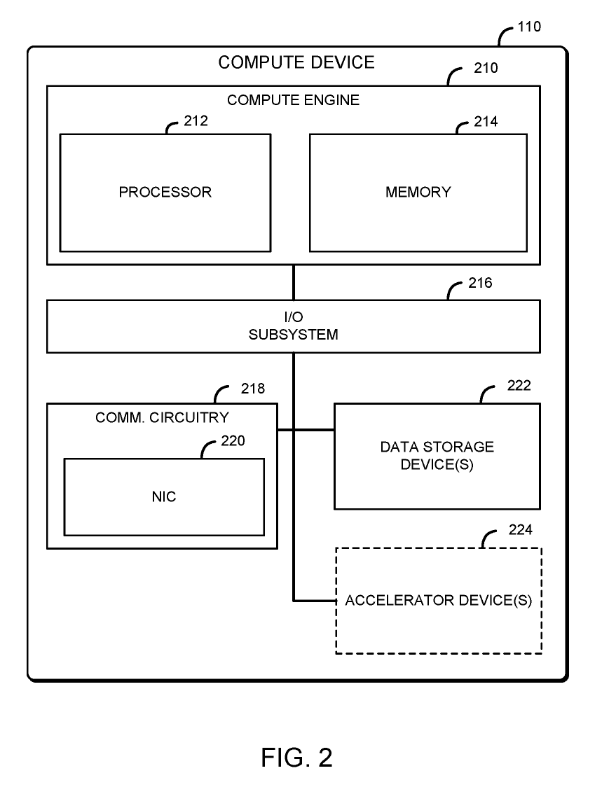

Referring now to FIG. 2, the illustrative compute device 110 includes a compute engine (also referred to herein as “compute engine circuitry”) 210, an input/output (I/O) subsystem 216, communication circuitry 218, one or more data storage devices 222, and may include one or more accelerator devices 224. Of course, in other embodiments, the compute device 110 may include other or additional components, such as those commonly found in a computer (e.g., a display, peripheral devices, etc.). Additionally, in some embodiments, one or more of the illustrative components may be incorporated in, or otherwise form a portion of, another component. Further, while shown as a single unit, it should be understood that in some embodiments, the components of the compute device 110 may be disaggregated (e.g., distributed across racks in a data center). The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. In the illustrative embodiment, the compute engine 210 includes or is embodied as a processor 212 and a memory 214. The processor 212 may be embodied as any type of processor capable of performing the functions described herein. For example, the processor 212 may be embodied as a multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the main memory 214 may be integrated into the processor 212. In operation, the main memory 214 may store various software and data used during operation such as applications, data operated on by the applications, the function dependency graph 170, libraries, and drivers.

The compute engine 210 is communicatively coupled to other components of the compute device 110 via the I/O subsystem 216, which may be embodied as circuitry and/or components to facilitate input/output operations with the compute engine 210 (e.g., with the processor 212 and/or the main memory 214) and other components of the compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the compute device 110, into the compute engine 210.

The communication circuitry 218 may be embodied as any communication circuit, device, or collection thereof, capable of enabling communications over the network 130 between the compute device 110 and another compute device (e.g., the compute device 112, the client device 120, etc.). The communication circuitry 218 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 218 includes a network interface controller (NIC) 220, which may also be referred to as a host fabric interface (HFI). The NIC 220 may be embodied as one or more add-in-boards, daughter cards, network interface cards, controller chips, chipsets, or other devices that may be used by the compute device 110 to connect with another compute device (e.g., the compute device 112, the client device 120, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. In such embodiments, the local processor of the NIC 220 may be capable of performing one or more of the functions of the compute engine 210 described herein. Additionally or alternatively, in such embodiments, the local memory of the NIC 220 may be integrated into one or more components of the compute device 110 at the board level, socket level, chip level, and/or other levels.

The one or more illustrative data storage devices 222 may be embodied as any type of devices configured for short-term or long-term storage of data such as, for example, memory devices and circuits, memory cards, hard disk drives, solid-state drives, or other data storage devices. Each data storage device 222 may include a system partition that stores data and firmware code for the data storage device 222. Each data storage device 222 may also include one or more operating system partitions that store data files and executables for operating systems and/or may store the function dependency graph 170.

The compute device 110 may additionally include one or more accelerator devices 224. Each accelerator device 224 may be embodied as any device or circuitry (e.g., a field programmable gate array (FPGA), a graphics processor unit (GPU), a network processor unit (NPU), a neural network processor unit (NNPU), an application specific integrated circuit (ASIC), a co-processor, etc.) capable of executing a set of operations (e.g., a function) faster than the operations would otherwise be executed by a general purpose processor. In some embodiments, the operations of the function scheduler 150 may be performed by an accelerator device 224.

The compute device 112 and client device 120 may have components similar to those described in FIG. 2 with reference to the compute device 110. The description of those components of the compute device 110 is equally applicable to the description of components of the compute device 110, with the exception that, in some embodiments, the client device 120 does not include an accelerator device 224. Further, it should be appreciated that any of the compute devices 110, 112 and the client device 120 may include other components, sub-components, and devices commonly found in a computing device, which are not discussed above in reference to the compute device 110 and not discussed herein for clarity of the description.

As described above, the compute devices 110, 112 and the client device 120 are illustratively in communication via the network 130, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), a radio area network (RAN), digital subscriber line (DSL) networks, cable networks (e.g., coaxial networks, fiber networks, etc.), or any combination thereof.

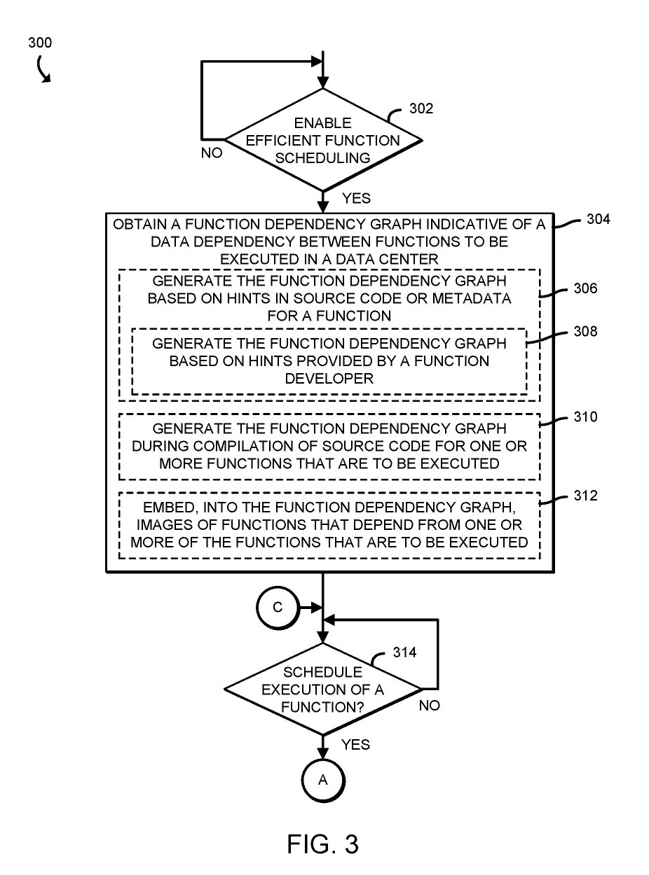

Referring now to FIG. 3, a compute device (e.g., the compute device 110) of the system 100, in operation, may execute, a method 300 for providing efficient scheduling of functions. The method 300 begins with block 302, in which the compute device 110 determines whether to enable efficient function scheduling. In doing so, in the illustrative embodiment, the compute device 110 may determine to enable efficient function scheduling based on a configuration setting (e.g., in a configuration file), in response to a detection that the compute device 110 is communicatively coupled to the network 130 and/or to one or more other compute devices (e.g., the compute device 112), in response to a request (e.g., from an administrator of the data center) to enable efficient scheduling, and/or based on other criteria. Regardless, in response to a determination not to enable efficient function scheduling, the method 300 may exit and the compute device 112 may instead perform another method (not shown) for scheduling functions without using the efficient function scheduling scheme described herein. In other embodiments, the method 300 loops back around to block 302 to again determine whether to enable efficient function scheduling (e.g., upon receipt of a request to do so, upon detecting a change in a configuration setting, etc.). It should be understood that the compute device 110 may concurrently perform other processes during the execution of the method 300 (e.g., the compute device 110 will not endlessly perform a loop in block 302 to the exclusion of other processes). In response to a determination to enable efficient scheduling of functions, the method 300, in the illustrative embodiment, advances to block 304, in which the compute device 110 obtains a function dependency graph 170 indicative of a data dependency between functions that are to be executed in the system 100 (e.g., in a data center in which the system 100 is located). In doing so, and as indicated in block 306, the compute device 110 may generate the function dependency graph 170 based on hints (e.g., any data indicative of a dependency of one function on the output data of one or more other functions) in the source code or metadata (e.g., a separate file associated with the binary code of the functions, etc.) associated with the functions. For example, and as indicated in block 308, the compute device 110 may generate the function dependency graph 170 based on hints provided by a developer (e.g., a software developer) of the functions.

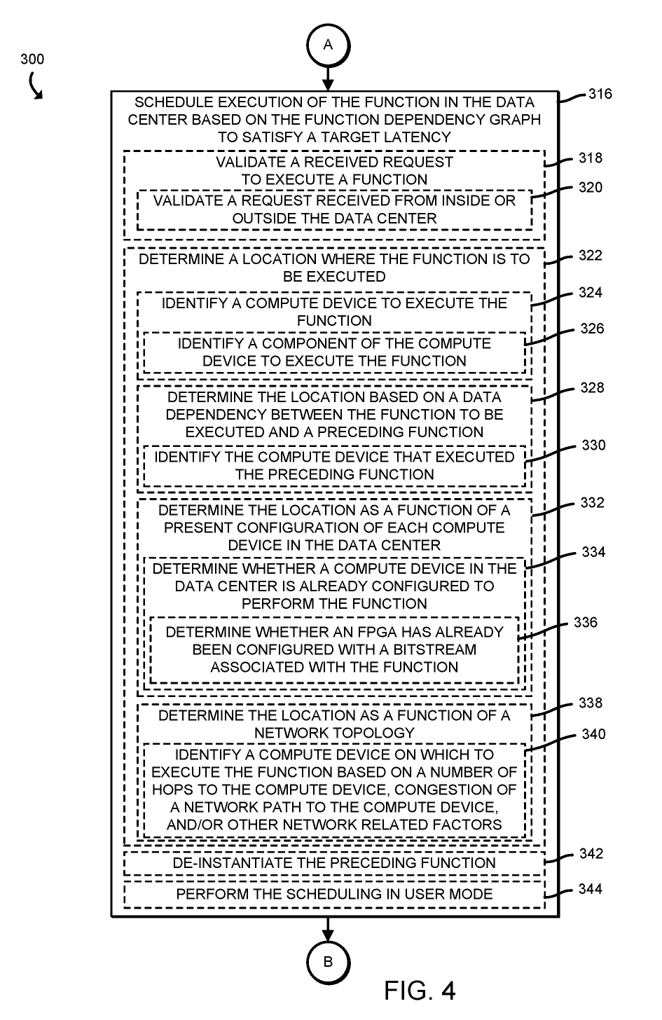

As indicated in block 310, the compute device 110 may additionally or alternatively generate the function dependency graph 170 during compilation of source code that defines the functions that are to be executed (e.g., the compute device 110 may receive and compile the source code, and in the process of compilation, identify, from calls from one function to other functions, a dependency between the functions). As indicated in block 312, the compute device 110 may embed, into the function dependency graph 170, images (e.g., executable code) of the functions have a data dependency between them. In block 314, the compute device 110 determines whether to schedule execution of a function (e.g., in response to a request from the client device 120 to execute one of the functions). If so, the method 300 advances to block 316 of FIG. 4, in which the compute device 110 schedules execution of the function in the system 100 based on the function dependency graph, to satisfy a target latency (e.g., a latency specified in a service level agreement with a customer associated with the function). In some embodiments, if the compute device 110 determines not to schedule execution of a function, the method 300 loops back to block 314 to await a request or other condition that will cause the compute device 110 to determine to schedule execution of a function. In other embodiments, the method 300 may terminate.

Referring now to FIG. 4, in scheduling execution of the function, the compute device 110 may validate a received request to execute the function, as indicated in block 318. For example, the compute device 110 may determine whether the request identifies a function that is available to be executed (e.g., the function is represented in the function dependency graph 170 or is otherwise known to the system 100). As indicated in block 320, the request may be received from outside the data center in which the compute devices 110, 112 are located (e.g., from the client device 120) or may originate from within the data center (e.g., from one of the compute devices 110, 112 during the execution of another function). If the request is not validated, the compute device 110 may, in some embodiments, return to block 314 to determine whether to schedule execution of another function. As indicated in block 322, the compute device 110 determines a location where the function is to be executed. In doing so, in the illustrative embodiment, the compute device 110 identifies a compute device in the system 100 to execute the function, as indicated in block 324. In doing so, the compute device 110 may determine a particular component (e.g., a particular accelerator device 224) of the compute device to execute the function, to satisfy the latency target, as indicated in block 326. As indicated in block 328, the compute device 110 may determine the location (e.g., the compute device that should execute the function) based on a data dependency between the function to be executed and a preceding function. For example, and as indicated in block 330, the compute device 110 may identify the compute device that executed the preceding function (e.g., an already-executed function that produced output data that present function will use as input data) as the compute device that should execute the present function (e.g., to enable the present function to access the output data from the memory 214 rather than requesting the data from another compute device and receiving it through the network 130, incurring additional latency in the process).

As indicated in block 332, the compute device 110 may determine the location as a function of the present configuration of each compute device 110, 112 in the system 100. For example, and as indicated in block 334, the compute device 110 may determine whether a compute device 110, 112 in the system 100 is already configured to execute the function (e.g., the function has already been instantiated in a virtual machine or container on one of the compute devices 110, 112). In doing so, the compute device 110 may determine whether a supportive compute device (e.g., an accelerator device 224, such as an FPGA, a graphics processor unit (GPU), a network processor unit (NPU), and/or a neural network processor unit (NNPU)) has been configured to execute the function. For example, and as indicated in block 336, the compute device 110 may determine whether an FPGA (e.g., an accelerator device 224) of one of the compute devices 110, 112 has already been configured with a bitstream (e.g., a set of code defining a hardware configuration for the gates of the FPGA to enable the FPGA to implement the function) associated with the function.

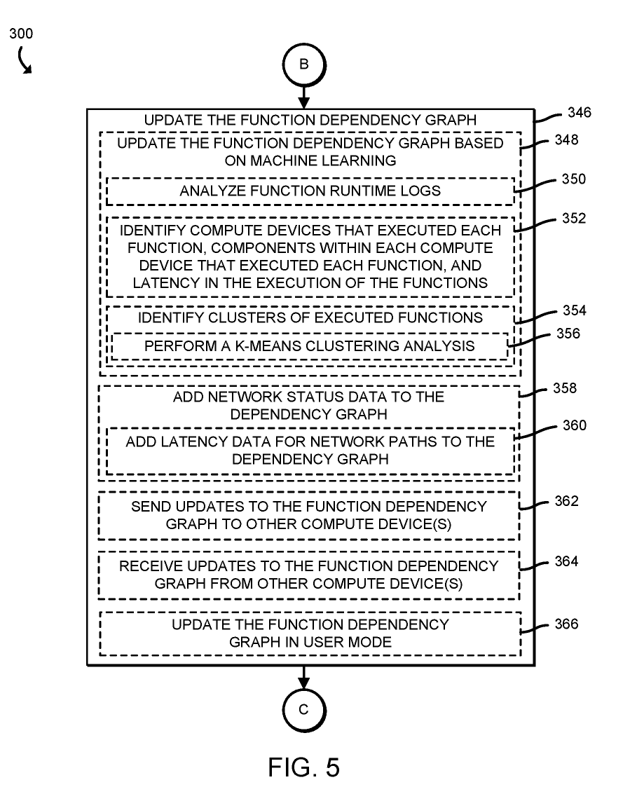

Additionally or alternatively, the compute device 110 may determine the location of where the function should be executed based on network topology information, as indicated in block 338. Further, in doing so and as indicated in block 340, the compute device 110 may determine a compute device on which the function should be executed based on a number of hops to the compute device (e.g., a number of networking devices, such as switches or routers, between a compute device that executed a preceding function that produced output data usable by the present function as input data, and the compute device that is to execute the present function), an amount of congestion (e.g., amount of available throughput that is already being used) of a network path to the compute device, and/or other network related factors (e.g., reliability of the network path). In doing so, the compute device 110 may select, as the execution location, the compute device having the network path with the lowest amount of hops or other factors that could minimize latency (e.g., least amount of congestion). As indicated in block 342, the compute device 110 may also cause the preceding function to be de-instantiated (e.g., by terminating a virtual machine in which the preceding function was executed). In some embodiments and as indicated in block 344, the compute device 110 may perform the scheduling operations of block 316 in user mode, rather than in a kernel mode. While described as being performed by the compute device 110, in some embodiments, the compute device 110 may coordinate with one or more other compute devices in the system 100 (e.g., the compute device 112) to perform the operations of block 316. Subsequently, the method 300 advances to block 346 of FIG. 5, in which the compute device 110 updates the function dependency graph 170.

Referring now to FIG. 5, in updating the function dependency graph 170, the compute device 110 may update the function dependency graph 170 using machine learning, as indicated in block 348. For example, and as indicated in block 350, the compute device 110 may analyze function runtime logs (e.g., data indicative of functions that were executed on each compute device 110, 112, when the functions were executed, what, if any, other functions were called by those functions, etc.) and, as indicated in block 352, the compute device 110 may identify (e.g., from the function runtime logs), the compute devices 110, 112 that executed each function, components within each compute device 110, 112 (e.g., processors 212, accelerator devices 224) that executed each function, and latency in executing each function (e.g., total elapsed time between the request to execute the function and completion of the function). As indicated in block 354, the compute device 110 may identify clusters of executed functions (e.g., groups of functions that were executed within a predefined time period, potentially indicating data dependency with each other). In doing so, and as indicated in block 356, the compute device 110 may perform a k-means clustering analysis to identify the clusters. As indicated in block 358, the compute device 110 may add network status data to the function dependency graph 170. In doing so, and as indicated in block 360, the compute device 110 may add latency data for one or more network paths (e.g., between two compute devices 110, 112) to the function dependency graph 170 to indicate a potential latency that may be incurred by using one or more of those paths in the future to transfer output data produced by a function on one compute device (e.g., the compute device 110) through the network 130 to another compute device 112 for use by a dependent function. As indicated in block 362, the compute device 110 may send updates (e.g., the updates determined in block 348 and/or the network status data added in block 358) to other compute devices (e.g., the compute device 112). Similarly, the compute device 110 may receive updates to the function dependency graph 170 from other compute device(s) (e.g., the compute device 112), as indicated in block 364. Further, and as indicated in block 366, the compute device 110 may perform the operations of block 346 in user mode, rather than in a kernel mode. Subsequently, the method 300 loops back to block 314 of FIG. 3, in which the compute device 110 determines whether to schedule execution of another function (e.g., a function requested by the client device 120 or a function called by another function that is being executed by one of the compute devices 110, 112 in the system 100).

### EXAMPLES

Illustrative examples of the technologies disclosed herein are provided below. An embodiment of the technologies may include any one or more, and any combination of, the examples described below.

Example 1 includes a compute device comprising a compute engine configured to obtain a function dependency graph indicative of data dependencies between functions to be executed in a networked set of compute devices; perform a cluster analysis of the execution of the functions in the networked set of compute devices to identify additional data dependencies between the functions; and update, based on the cluster analysis, the function dependency graph.

Example 2 includes the subject matter of Example 1, and wherein to obtain the function dependency graph comprises to generate the function dependency graph from hints in source code or metadata associated with one or more of the functions.

Example 3 includes the subject matter of any of Examples 1 and 2, and wherein to obtain the function dependency graph comprises to generate the function dependency graph during a compilation process for source code defining one or more of the functions to be executed.

Example 4 includes the subject matter of any of Examples 1-3, and wherein the compute engine is further configured to schedule, based on the function dependency graph and to satisfy a target latency in the execution of the functions, execution of the functions in the networked set of compute devices.

Example 5 includes the subject matter of any of Examples 1-4, and wherein to schedule execution of the functions comprises to identify a compute device in the networked set of compute devices to execute each function.

Example 6 includes the subject matter of any of Examples 1-5, and wherein to identify a compute device to execute each function further comprises to identify a component of the compute device to execute each function.

Example 7 includes the subject matter of any of Examples 1-6, and wherein to schedule execution of the functions in the networked set of compute devices comprises to determine a compute device on which to execute a function based on a data dependency between the function to be executed and a preceding function.

Example 8 includes the subject matter of any of Examples 1-7, and wherein the compute engine is further configured to schedule the function to be executed on the same compute device that executed the preceding function.

Example 9 includes the subject matter of any of Examples 1-8, and wherein to schedule execution of the functions in the networked set of compute devices comprises to determine, as a function of a present configuration of each compute device in the networked set of compute devices, a location where each function is to be executed.

Example 10 includes the subject matter of any of Examples 1-9, and wherein the compute engine is further configured to determine whether a compute device in the networked set of compute devices is already configured to perform one of the functions that is to be executed.

Example 11 includes the subject matter of any of Examples 1-10, and wherein the compute engine is further configured to determine whether an accelerator device in one of the compute devices in the networked set of compute devices has already been configured to perform one of the functions that is to be executed.

Example 12 includes the subject matter of any of Examples 1-11, and wherein to schedule execution of the functions in the networked set of compute devices comprises to determine a location of where one of the functions is to be executed based on a topology of a network that connects the compute devices.

Example 13 includes the subject matter of any of Examples 1-12, and wherein to perform a cluster analysis comprises to perform a k-means cluster analysis on function runtime logs produced in the execution of the functions.

Example 14 includes the subject matter of any of Examples 1-13, and wherein the compute engine is further to send, to one or more other compute devices in the networked set of compute devices, updates to the function dependency graph.

Example 15 includes one or more machine-readable storage media comprising a plurality of instructions stored thereon that, in response to being executed, cause a compute device to obtain a function dependency graph indicative of data dependencies between functions to be executed in a networked set of compute devices; perform a cluster analysis of the execution of the functions in the networked set of compute devices to identify additional data dependencies between the functions; and update, based on the cluster analysis, the function dependency graph.

Example 16 includes the subject matter of Example 15, and wherein the plurality of instructions further cause the compute device to generate the function dependency graph from hints in source code or metadata associated with one or more of the functions.

Example 17 includes the subject matter of any of Examples 15 and 16, and wherein the plurality of instructions further cause the compute device to generate the function dependency graph during a compilation process for source code defining one or more of the functions to be executed.

Example 18 includes the subject matter of any of Examples 15-17, and wherein the plurality of instructions further cause the compute device to schedule, based on the function dependency graph and to satisfy a target latency in the execution of the functions, execution of the functions in the networked set of compute devices.

Example 19 includes the subject matter of any of Examples 15-18, and wherein the plurality of instructions further cause the compute device to identify a compute device in the networked set of compute devices to execute each function.

Example 20 includes the subject matter of any of Examples 15-19, and wherein the plurality of instructions further cause the compute device to identify a component of the compute device to execute each function.

Example 21 includes the subject matter of any of Examples 15-20, and wherein the plurality of instructions further cause the compute device to determine a compute device on which to execute a function based on a data dependency between the function to be executed and a preceding function.

Example 22 includes the subject matter of any of Examples 15-21, and wherein the plurality of instructions further cause the compute device to schedule the function to be executed on the same compute device that executed the preceding function.

Example 23 includes a method comprising obtaining, by a compute device, a function dependency graph indicative of data dependencies between functions to be executed in a networked set of compute devices; performing, by the compute device, a cluster analysis of the execution of the functions in the networked set of compute devices to identify additional data dependencies between the functions; and updating, by the compute device and based on the cluster analysis, the function dependency graph.

Example 24 includes the subject matter of Example 23, and further including scheduling, by the compute device and based on the function dependency graph and to satisfy a target latency in the execution of the functions, execution of the functions in the networked set of compute devices.

1. A compute device comprising:
a compute engine configured to:
obtain a function dependency graph indicative of data dependencies between functions to be executed in a networked set of compute devices;
perform a cluster analysis of the execution of the functions in the networked set of compute devices to identify additional data dependencies between the functions; and
update, based on the cluster analysis, the function dependency graph.

2. The compute device of claim 1, wherein to obtain the function dependency graph comprises to generate the function dependency graph from hints in source code or metadata associated with one or more of the functions.

3. The compute device of claim 1, wherein to obtain the function dependency graph comprises to generate the function dependency graph during a compilation process for source code defining one or more of the functions to be executed.

4. The compute device of claim 1, wherein the compute engine is further configured to schedule, based on the function dependency graph and to satisfy a target latency in the execution of the functions, execution of the functions in the networked set of compute devices.

5. The compute device of claim 4, wherein to schedule execution of the functions comprises to identify a compute device in the networked set of compute devices to execute each function.

6. The compute device of claim 5, wherein to identify a compute device to execute each function further comprises to identify a component of the compute device to execute each function.

7. The compute device of claim 5, wherein to schedule execution of the functions in the networked set of compute devices comprises to determine a compute device on which to execute a function based on a data dependency between the function to be executed and a preceding function.

8. The compute device of claim 7, wherein the compute engine is further configured to schedule the function to be executed on the same compute device that executed the preceding function.

9. The compute device of claim 4, wherein to schedule execution of the functions in the networked set of compute devices comprises to determine, as a function of a present configuration of each compute device in the networked set of compute devices, a location where each function is to be executed.

10. The compute device of claim 9, wherein the compute engine is further configured to determine whether a compute device in the networked set of compute devices is already configured to perform one of the functions that is to be executed.

11. The compute device of claim 10, wherein the compute engine is further configured to determine whether an accelerator device in one of the compute devices in the networked set of compute devices has already been configured to perform one of the functions that is to be executed.

12. The compute device of claim 4, wherein to schedule execution of the functions in the networked set of compute devices comprises to determine a location of where one of the functions is to be executed based on a topology of a network that connects the compute devices.

13. The compute device of claim 1, wherein to perform a cluster analysis comprises to perform a k-means cluster analysis on function runtime logs produced in the execution of the functions.

14. The compute device of claim 1, wherein the compute engine is further to send, to one or more other compute devices in the networked set of compute devices, updates to the function dependency graph.

15. One or more machine-readable storage media comprising a plurality of instructions stored thereon that, in response to being executed, cause a compute device to:
obtain a function dependency graph indicative of data dependencies between functions to be executed in a networked set of compute devices;
perform a cluster analysis of the execution of the functions in the networked set of compute devices to identify additional data dependencies between the functions; and
update, based on the cluster analysis, the function dependency graph.

16. The one or more machine-readable storage media of claim 15, wherein the plurality of instructions further cause the compute device to generate the function dependency graph from hints in source code or metadata associated with one or more of the functions.

17. The one or more machine-readable storage media of claim 15, wherein the plurality of instructions further cause the compute device to generate the function dependency graph during a compilation process for source code defining one or more of the functions to be executed.

18. The one or more machine-readable storage media of claim 15, wherein the plurality of instructions further cause the compute device to schedule, based on the function dependency graph and to satisfy a target latency in the execution of the functions, execution of the functions in the networked set of compute devices.

19. The one or more machine-readable storage media of claim 18, wherein the plurality of instructions further cause the compute device to identify a compute device in the networked set of compute devices to execute each function.

20. The one or more machine-readable storage media of claim 19, wherein the plurality of instructions further cause the compute device to identify a component of the compute device to execute each function.

21. The one or more machine-readable storage media of claim 19, wherein the plurality of instructions further cause the compute device to determine a compute device on which to execute a function based on a data dependency between the function to be executed and a preceding function.

22. The one or more machine-readable storage media of claim 21, wherein the plurality of instructions further cause the compute device to schedule the function to be executed on the same compute device that executed the preceding function.

23. A method comprising:
obtaining, by a compute device, a function dependency graph indicative of data dependencies between functions to be executed in a networked set of compute devices;
performing, by the compute device, a cluster analysis of the execution of the functions in the networked set of compute devices to identify additional data dependencies between the functions; and
updating, by the compute device and based on the cluster analysis, the function dependency graph.

24. The method of claim 23, further comprising scheduling, by the compute device and based on the function dependency graph and to satisfy a target latency in the execution of the functions, execution of the functions in the networked set of compute devices.
